(19) United States
(12) Patent Application Publication
(10) Pub. No.: US 2026/0321598 A1
(43) Pub. Date: Oct. 15, 2026

(54) POSITIVE ELECTRODE ACTIVE MATERIAL, POSITIVE ELECTRODE, AND SECONDARY BATTERY

(71) Applicant: MURATA MANUFACTURING CO., LTD., Kyoto (JP)

(72) Inventor: Kei HASEGAWA, Kyoto (JP)

(21) Appl. No.: 19/462,451

(22) Filed: Jan. 28, 2026

Related U.S. Application Data
(63) Continuation of application No. PCT/JP2024/027364, filed on Jul. 31, 2024.

(30) Foreign Application Priority Data
Sep. 28, 2023 (JP) 2023-168604

(51) Int. Cl. H01M 4/36; H01M 4/02; H01M 4/525; H01M 4/62

(52) U.S. Cl. CPC H01M 4/366; H01M 4/525; H01M 4/624; H01M 4/628; H01M 2004/021

(57) ABSTRACT

A positive electrode active material is provided and includes a lithium nickel oxide and zirconium oxide. The lithium nickel oxide is represented by a composition formula of Li_{d}Ni_{1-a-b-c}CoₐAl_{b}M_{c}O₂, where M is at least one element selected from Na, Cu, W, Fe, and Zn, and 0≤a≤0.2, 0≤b≤0.2, 0≤c≤0.1, and 0.90≤d≤1.1 are satisfied.

### CROSS REFERENCE TO RELATED APPLICATIONS

The present application is a continuation of International Patent Application No. PCT/JP2024/027364, filed on Jul. 31, 2024, which claims priority to Japanese Patent Application No. 2023-168604, filed on Sep. 28, 2023, the entire contents of which are incorporated herein by reference.

### BACKGROUND

The present application relates to a positive electrode active material, a positive electrode, and a secondary battery.

A positive electrode material is disclosed containing a mixture of a positive electrode active material and lithium zirconate which is an oxide containing zirconium.

### SUMMARY

The present application relates to a positive electrode active material, a positive electrode, and a secondary battery.

However, the secondary battery referenced in the Background section has a possibility of deterioration in the cycle characteristics.

The present application has been made in view of the above problems, and relates to providing a positive electrode active material, a positive electrode, and a secondary battery having high cycle characteristics according to an embodiment.

A positive electrode active material according to an embodiment of the present application includes a lithium nickel oxide and zirconium oxide, wherein the lithium nickel oxide is represented by a composition formula of Li_{d}Ni_{1-a-b-c}CoₐAl_{b}M_{c}O₂, where M is at least one element selected from Na, Cu, W, Fe, and Zn, and 0≤a≤0.2, 0≤b≤0.2, 0≤c≤0.1, and 0.90≤d≤1.1 are satisfied.

A positive electrode according to an embodiment of the present application contains the positive electrode active material.

A secondary battery according to an embodiment of the present application includes a positive electrode containing the positive electrode active material, a negative electrode, a separator interposed between the positive electrode and the negative electrode, and an electrolytic solution.

The present application can provide a positive electrode active material, a positive electrode, and a secondary battery having high cycle characteristics.

### BRIEF DESCRIPTION OF THE FIGURES

FIG. 1 is a sectional view illustrating an example of a secondary battery according to an embodiment.

FIG. 2 is an enlarged sectional view illustrating a part of a section of an electrode body according to FIG. 1.

FIG. 3 is a schematic sectional view illustrating a part of positive electrode active material particles according to an embodiment.

FIG. 4 is a cutaway view illustrating another example of the secondary battery according to an embodiment.

FIG. 5 is a schematic sectional view taken along the line V-V in FIG. 4.

### DETAILED DESCRIPTION

Hereinafter, the present application will be described in further detail including with reference to the drawings according to an embodiment. The present application is not limited thereby.

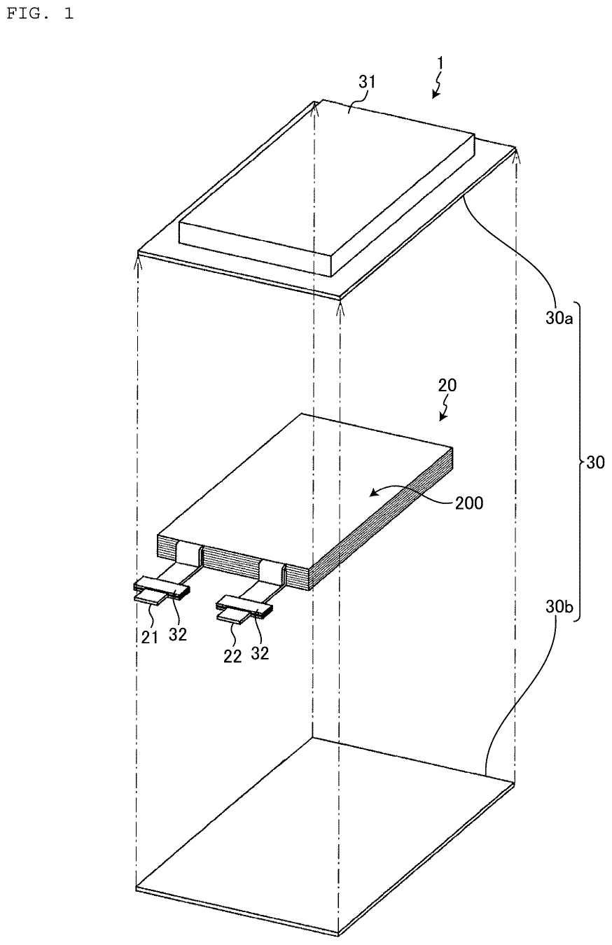

FIG. 1 is a sectional view illustrating an example of a secondary battery according to a first embodiment. A secondary battery 1 illustrated in FIG. 1 is a laminate type lithium ion secondary battery. As illustrated in FIG. 1, the secondary battery 1 includes a battery element 20, an exterior member 30, and a close contact member 32.

The battery element 20 is provided inside the exterior member 30. As illustrated in FIG. 1, the battery element 20 includes an electrode body 200, a positive electrode lead 21, and a negative electrode lead 22. The positive electrode lead 21 is a terminal drawn out from a positive electrode 210 described later to the outside of the exterior member 30. That is, the positive electrode lead 21 is a terminal serving as a plus electrode of the secondary battery 1. In FIG. 1, the positive electrode lead 21 is provided on an end surface of the electrode body 200. The negative electrode lead 22 is a terminal drawn out from the inside of a negative electrode 220 described later to the outside of the exterior member 30. That is, the negative electrode lead 22 is a terminal serving as a minus electrode of the secondary battery 1. In FIG. 1, the negative electrode lead 22 is provided on an end surface of the electrode body 200. Details of the electrode body 200 will be described later.

The exterior member 30 is a case in which the battery element 20 is housed. The exterior member 30 includes two exterior sheets 30a and 30b. The exterior sheets 30a and 30b each include an insulating layer, a metal layer, and an outermost layer. In the example of FIG. 1, a recess 31 is provided in the exterior sheet 30a. With this configuration, the battery element 20 is housed in the recess 31, and the peripheral edges of the exterior sheets 30a and 30b are bonded, whereby the battery element 20 is housed in the exterior member 30.

The exterior sheets 30a and 30b have a structure in which the insulating layer, the metal layer, and the outermost layer are stacked in this order from the inside, namely, from the side where the battery element 20 is provided, and bonded through lamination processing or the like. The insulating layer of each of the exterior sheets 30a and 30b is made of, for example, a resin such as polyethylene, polypropylene, modified polyethylene, modified polypropylene, or a polyolefin resin containing ethylene or propylene as a monomer. This allows the exterior sheets 30a and 30b to lower the moisture permeability of the secondary battery 1 and to improve the airtightness. The metal layer of each of the exterior sheets 30a and 30b is a plate material or a foil material of metal such as aluminum, stainless steel, nickel, or iron. The outermost layer may be made of any material, but is preferably made of a material having high strength against breakage, piercing, or the like, such as a resin similar to that of the insulating layer, or nylon.

The close contact member 32 is a member for making the exterior member 30 airtight. The close contact member 32 is provided between the exterior member 30 and the positive electrode lead 21 and between the exterior member 30 and the negative electrode lead 22. The material of the close contact member 32 preferably has a close contact property with respect to the positive electrode lead 21 and the negative electrode lead 22. For example, when the positive electrode lead 21 and the negative electrode lead 22 are each made of a metal material, a polyolefin resin such as polyethylene, polypropylene, modified polyethylene, or modified polypropylene is used as the close contact member 32. This allows the close contact member 32 to keep the gap between the exterior member 30 and the positive electrode lead 21 and the gap between the exterior member 30 and the negative electrode lead 22 airtight, and thus, the inside of the exterior member 30 can be made airtight.

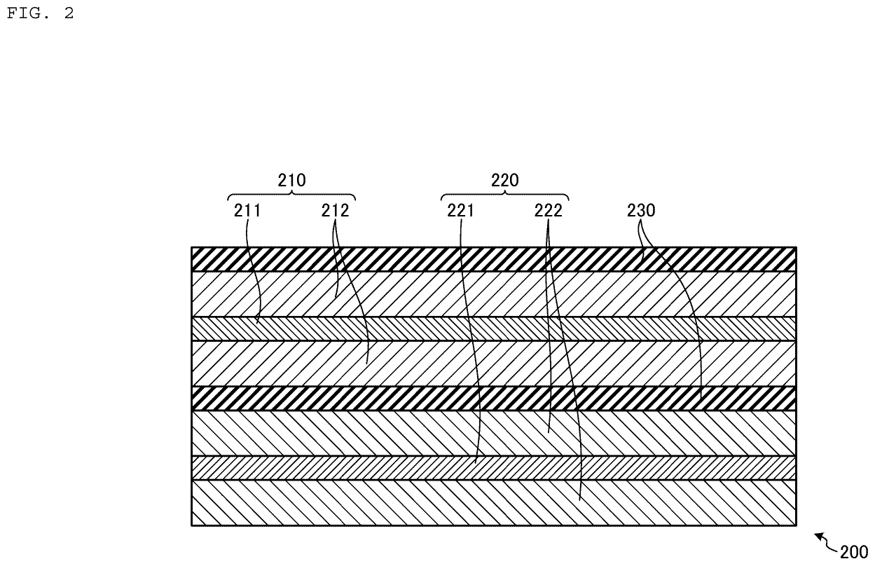

FIG. 2 is an enlarged sectional view illustrating a part of a section of the electrode body according to FIG. 1. More specifically, FIG. 2 is a sectional view illustrating a part of one layer of the positive electrode 210 and one layer of the negative electrode 220 in the electrode body 200. As illustrated in FIG. 2, the electrode body 200 includes the positive electrode 210, the negative electrode 220, and a separator 230. In the secondary battery 1, the electrode body 200 has a structure in which the positive electrode 210 and the negative electrode 220 are stacked in a thickness direction with the separator 230 interposed therebetween. The positive electrode 210 and the negative electrode 220 included in the electrode body 200 are each a layered member for a charge-discharge reaction of the secondary battery 1 according to the first embodiment.

The positive electrode 210 includes a positive electrode current collector 211 and positive electrode active material layers 212. In the positive electrode 210, the positive electrode current collector 211 is stacked between the positive electrode active material layers 212.

The positive electrode current collector 211 is a conductive layer and, for example, an aluminum foil, a stainless steel foil, or the like can be used. In the example of FIG. 1, the shape of the positive electrode current collector 211 is a rectangular sheet having a projection on the positive electrode lead 21 side in plan view in the thickness direction. The projection of the positive electrode current collector 211 is connected to the positive electrode lead 21.

The positive electrode active material layer 212 is a layer containing a positive electrode active material. The positive electrode active material contains a lithium nickel oxide, and further contains zirconium oxide and a carbonate. This makes it possible to improve the cycle retention rate while suppressing gas generation from the battery.

The lithium nickel oxide according to the first embodiment has a composition formula of Li_{d}Ni_{1-a-b-c}CoₐAl_{b}M_{c}O₂. Here, M is at least one element selected from Na, Cu, W, Fe, and Zn. In addition, 0≤a≤0.2, 0≤b≤0.2, 0≤c≤0.1, and 0.90≤d≤1.1 are satisfied. That is, the lithium nickel oxide does not have to contain Co, Al, or M. The values of M and a, b, and c of the lithium nickel oxide can be measured by inductively coupled plasma (ICP) emission spectrometry. The lithium nickel oxide preferably contains Co and Al. That is, in the above-described composition formula, it is preferable to satisfy 0<a≤0.2 and 0<b≤0.2, and it is more preferable to satisfy 0.01≤a≤0.2 and 0.01≤b≤0.2. In this case, the addition of Co and Al improves the chemical stability of the lithium nickel oxide.

The crystal system of the zirconium oxide is monoclinic, tetragonal, or cubic. The crystal system of the zirconium oxide is preferably monoclinic or tetragonal. This can further improve the cycle retention rate.

The crystal system of the zirconium oxide can be identified by electron beam diffraction using a transmission electron microscope (TEM). More specifically, the crystal system of the zirconium oxide can be specified by the following method. First, measure a sample containing the positive electrode active material with a TEM. Next, specify a region containing Zr with an energy dispersive X-ray spectroscopy (EDX) accompanying the TEM. Then, the crystal system of the zirconium oxide can be determined by acquiring the electron beam diffraction pattern of the specified region containing Zr. For example, when the diffraction pattern belongs to the space group P2₁/c, it can be said that the crystal system is monoclinic, when the diffraction pattern belongs to the space group P4₂/nmc, it can be said that the crystal system is tetragonal, and when the diffraction pattern belongs to Fm-3m, it can be said that the crystal system is cubic.

The content of the zirconium oxide is preferably 0.0001 or more and 0.01 or less, more preferably 0.0002 or more and 0.005 or less in terms of mole ratio, with respect to the content of nickel in the lithium nickel oxide in the positive electrode active material. The content of the zirconium oxide is obtained by performing X-ray photoelectron spectroscopy (XPS) analysis on the positive electrode active material layer and quantitatively analyzing the amount of zirconium atoms.

The carbonate is a salt of a cation and a carbonate ion (CO₃²⁻). The cation contains at least one element selected from K, Ca, Ba, Mg, Fe, Co, Na, Mn, Ni, Zn, Rb, Sr, Cs, Cd, and Ag. As a result, a solid solution is formed with lithium carbonate through heating in the production of the positive electrode active material layer 212, and the melting point of lithium carbonate is lowered. Thus, bonding properties between lithium nickel oxide particles improve, and gas generation from the battery can be further suppressed.

The content of the carbonate is preferably 0.0002 or more and 0.02 or less, more preferably 0.0004 or more and 0.01 or less in terms of mole ratio, with respect to the content of nickel in the lithium nickel oxide in the positive electrode active material. The content of the carbonate can be obtained by quantitatively analyzing the amount of carbon atoms in carbonate ions through XPS analysis on the positive electrode active material layer.

The positive electrode active material layer 212 is not limited to the above-described materials, and it may further contain, for example, a positive electrode binder, a positive electrode conductive additive, and a dispersant.

The positive electrode binder may be any material, and it contains, for example, one or more of synthetic rubber and a polymer compound. Examples of the synthetic rubber include a styrene-butadiene-based rubber, a fluorine-based rubber, and ethylene propylene diene. Examples of the polymer compound include a polyvinylidene fluoride (PVdF) and a polyimide.

The positive electrode conductive additive may be any material, and it contains, for example, carbon. Examples of the carbon include graphite, carbon black, acetylene black, and Ketjen black. The positive electrode conductive additive is not limited to these materials, and it may be a metal material, a conductive polymer, or the like as long as the material is a conductive material.

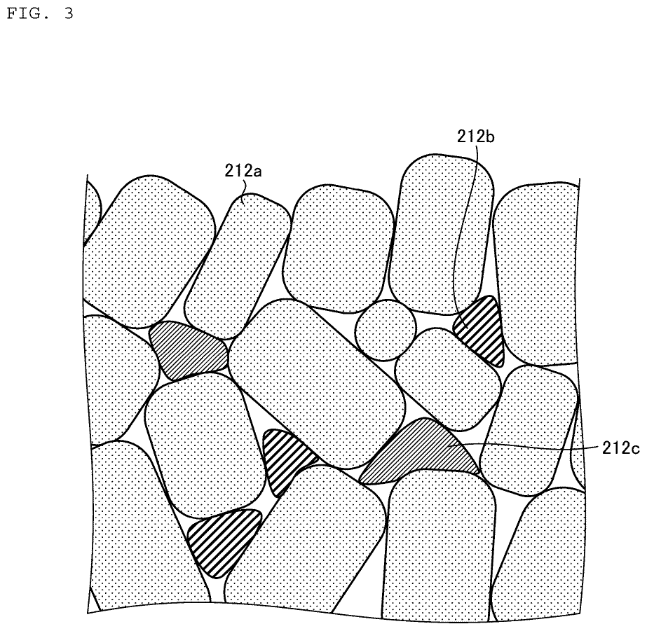

FIG. 3 is a schematic sectional view illustrating a part of positive electrode active material particles according to the first embodiment.

In the first embodiment, the positive electrode active material layer 212 is a layer in which secondary particles are gathered. In the secondary particles, a plurality of lithium nickel oxide particles 212a (primary particles) are aggregated so as to be in contact with each other as illustrated in FIG. 3. The state of the lithium nickel oxide particles 212a in the positive electrode active material layer 212 can be evaluated by measuring a section of the positive electrode active material layer 212 with a scanning electron microscope (SEM) or by energy dispersive X-ray spectroscopy (EDX) mapping for Ni.

The average diameter of the lithium nickel oxide particles 212a is 0.1 μm or more and 3 μm or less. The average diameter of the lithium nickel oxide particles 212a in the positive electrode active material layer 212 can be evaluated by measuring a section of the positive electrode active material layer 212 with a SEM or by EDX mapping for Ni. More specifically, the average diameter of the lithium nickel oxide particles 212a can be calculated by observing the section of the positive electrode active material layer 212 with a SEM, calculating, the longest distance of the region surrounded by the surface or interface of each particle of 20 lithium nickel oxide particles in the obtained SEM observation image, and calculating the arithmetic average value of the longest distances.

The median diameter (D₅₀) of the secondary particles is 5 μm or more and 30 μm or less. The median diameter (D₅₀) of the secondary particles can be calculated from a frequency distribution curve measured by using a laser scattering particle size distribution measuring apparatus (for example, a laser diffraction/scattering type particle size distribution measuring apparatus LA-960 manufactured by HORIBA, Ltd.). A measurement sample for measurement of the median diameter (D₅₀) of the secondary particles is produced as follows. First, immerse the positive electrode 210 including the positive electrode current collector 211 and the positive electrode active material layer 212 in water or N-methylpyrrolidone to separate the positive electrode active material layer 212. Next, wash the separated positive electrode active material layer 212 with water or N-methylpyrrolidone, and disperse it in water or N-methylpyrrolidone to obtain a dispersion. Then, perform centrifugation on the dispersion to separate the secondary particles. Disperse the finally separated secondary particles in a medium composed of a mixture of water and N-methylpyrrolidone to obtain a measurement sample.

In the first embodiment, as illustrated in FIG. 3, a zirconium oxide 212b covers at least a part of a surface of the lithium nickel oxide particles 212a. In other words, the zirconium oxide 212b is present on the surface or the interface of the lithium nickel oxide particles 212a. This makes it possible to improve the conductivity between the lithium nickel oxide particles 212a. The distribution of the zirconium oxide 212b can be observed by EDX mapping for Zr in a section of the positive electrode active material layer 212. Here, when the region occupied by Zr, that is, the region where the zirconium oxide 212b is distributed is in contact with the surface or interface of the lithium nickel oxide particles 212a, it can be said that the zirconium oxide 212b covers at least a part of a surface of the lithium nickel oxide particles 212a.

In the first embodiment, as illustrated in FIG. 3, a carbonate 212c covers at least a part of a surface of the lithium nickel oxide particles 212a. In other words, the carbonate 212c is present on the surface or interface of the lithium nickel oxide particles 212a. This makes it possible to improve the binding properties between the lithium nickel oxide particles 212a. Here, the carbonate 212c is a mixture with lithium carbonate by substituting a part of cations with lithium. The distribution of the carbonate 212c can be observed, for example, by comparing EDX mappings for O, Ni, and Zr in a section of the positive electrode active material layer 212. Specifically, a region obtained by excluding a region where Ni contained in the positive electrode active material and a region where Zr contained in zirconium oxide are present from a region where O is present can be defined as the region where the carbonate 212c is distributed. Here, when the region where the carbonate 212c is distributed is in contact with the surface or interface of the lithium nickel oxide particles 212a, it can be said that the carbonate 212c covers at least a part of a surface of the lithium nickel oxide particles 212a.

The negative electrode 220 includes a negative electrode current collector 221 and negative electrode active material layers 222. In the negative electrode 220, the negative electrode current collector 221 is stacked between the negative electrode active material layers 222.

The negative electrode current collector 221 is a conductor, and for example, a copper foil or the like can be used. In the example of FIG. 1, the shape of the negative electrode current collector 221 is a rectangular sheet having a projection on the negative electrode lead 22 side in plan view in the thickness direction. The projection of the negative electrode current collector 221 is connected to the negative electrode lead 22.

The negative electrode active material layer 222 is a layer containing a negative electrode active material. The negative electrode active material layer 222 is not limited to being made of only the negative electrode active material, but it may contain, for example, a conductive additive and a binder.

The negative electrode active material refers to a reducing agent capable of absorbing and desorbing charge carriers of the secondary battery 1 through a charge-discharge reaction, such as a carbon material, a metal, a metalloid, an alloy or a compound of silicon, an alloy or a compound of tin (Sn), or the like.

Examples of the negative electrode active material containing silicon include a simple substance of silicon, an alloy of silicon, and a compound of silicon. Examples of the alloy of silicon that can be used as the negative electrode active material include those containing at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as a second constituent element other than silicon. Examples of the compound of silicon that can be used as the negative electrode active material include a compound of silicon containing oxygen (O) or carbon (C), such as silicon oxide (SiOₓ) and silicon carbide (Sic), and it may contain the above-described second constituent element in addition to silicon. The negative electrode active material may be doped with Li. When the negative electrode active material is SiOₓ, the SiOₓ is preferably pre-doped with Li by doping it with Li in the step of negative electrode production. This makes it possible to reduce the irreversible capacity of SiOₓ as the negative electrode active material. The negative electrode active material may be a composite of Si and another substance such as carbon, or a composite of a Si alloy and another substance such as carbon. In this case, the irreversible capacity can be reduced. In addition, it is preferable that the particle surface of the negative electrode active material is partly or fully covered with carbon. This can improve the electron conductivity of the particle surface of the negative electrode active material.

Examples of the carbon material that can be used as the negative electrode active material include mesocarbon microbeads (MCMB), artificial graphite, natural graphite, non-graphitizable carbon, and graphitizable carbon. More specifically, examples of the material that can be used as the negative electrode active material include pyrolytic carbons, cokes, glassy carbon fibers, organic polymer compound fired bodies, activated carbon, and carbon blacks. Examples of the cokes include pitch coke, needle coke, and petroleum coke. The organic polymer compound fired body is a substance obtained by firing a polymer compound such as a phenol resin and a furan resin at an appropriate temperature to carbonize it.

The negative electrode active material is not limited to those recited above, but it may contain other negative electrode active materials, for example, a material capable of occluding and releasing lithium, such as an alloy or compound of a metal or metalloid, or an alloy or compound of tin (Sn). Examples of the metal and the metalloid that can be used as the negative electrode active material include tin (Sn), lead (Pb), aluminum (Al), indium (In), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Among these, germanium, tin, and lead are preferable. Tin is more preferable because tin has a great ability to occlude and release lithium, and a high energy density can be obtained.

Examples of the alloy of tin that can be used as the negative electrode active material include an alloy including at least one from the group consisting of nickel, copper, iron, cobalt, manganese, zinc, indium, silver, titanium, germanium, bismuth, antimony, and chromium as the second constituent element other than tin. Examples of the compound of tin that can be used as the negative electrode active material include a compound including oxygen or carbon, and the compound of tin may include the above-described second constituent elements in addition to tin.

The separator 230 is a film that insulates the positive electrode 210 from the negative electrode 220. The separator 230 is provided between the positive electrode 210 and the negative electrode 220 such that the positive electrode 210 and the negative electrode 220 are not in direct contact with each other. In the example of FIG. 1, the shape of the separator 230 is a rectangular sheet in plan view in the thickness direction.

Preferably, the material of the separator 230 is electrically stable, is chemically stable against the positive electrode active material, the negative electrode active material, and the electrolytic solution, and has an insulating property. For the separator 230, a layer made of a polymer nonwoven fabric, a porous film, glass, or ceramic fibers can be used, for example. The material of the separator 230 more preferably includes a porous polyolefin film. This can improve the safety of the battery because of the effect of short circuit prevention and the effect of shutdown.

The separator 230 is impregnated with the electrolytic solution. In the example of FIG. 1, the electrolytic solution is filled into a space in the exterior member 30. The electrolytic solution is a non-aqueous electrolytic solution containing an electrolyte salt and a solvent that dissolves the electrolyte salt.

Examples of the electrolyte salt include lithium salts such as lithium perchlorate (LiClO₄), lithium hexafluorophosphate (LiPF₆), lithium tetrafluoroborate (LiBF₄), lithium bis(trifluoromethanesulfonyl)imide (LiN(SO₂CF₃)₂), lithium bis(pentafluoroethanesulfonyl)imide (LiN(SO₂C₂F₅)₂), and lithium hexafluoroarsenate (LiAsF₆).

Examples of the solvent include non-aqueous solvents including lactone-based solvents such as γ-butyrolactone, γ-valerolactone, δ-valerolactone, and ε-caprolactone, carbonate ester-based solvents such as ethylene carbonate, propylene carbonate, butylene carbonate, vinylene carbonate, dimethyl carbonate, ethyl methyl carbonate, and diethyl carbonate, ether-based solvents such as 1,2-dimethoxyethane, 1-ethoxy-2-methoxyethane, 1,2-diethoxyethane, tetrahydrofuran, and 2-methyltetrahydrofuran, nitrile-based solvents such as acetonitrile, sulfolane-based solvents, phosphoric acids, phosphoric acid ester solvents, and pyrrolidones.

The electrolytic solution may further contain an additive such as a fluorinated carboxylic acid ester, a sulfonic acid ester, a sulfonic acid anhydride, or a carboxylic acid anhydride as an additive.

Although the battery according to the first embodiment has been described above, the secondary battery according to the first embodiment is not limited to the battery illustrated in FIG. 1. Hereinafter, other examples will be described with reference to drawings, but configurations similar to those in FIGS. 1 and 2 are denoted by reference symbols, and description thereof will be omitted.

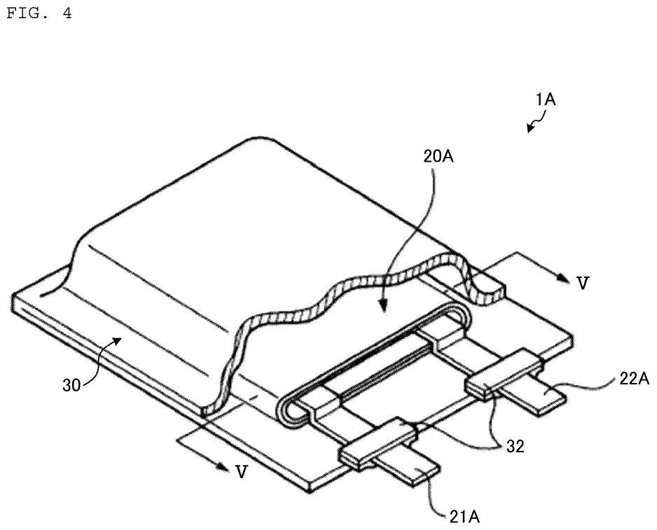

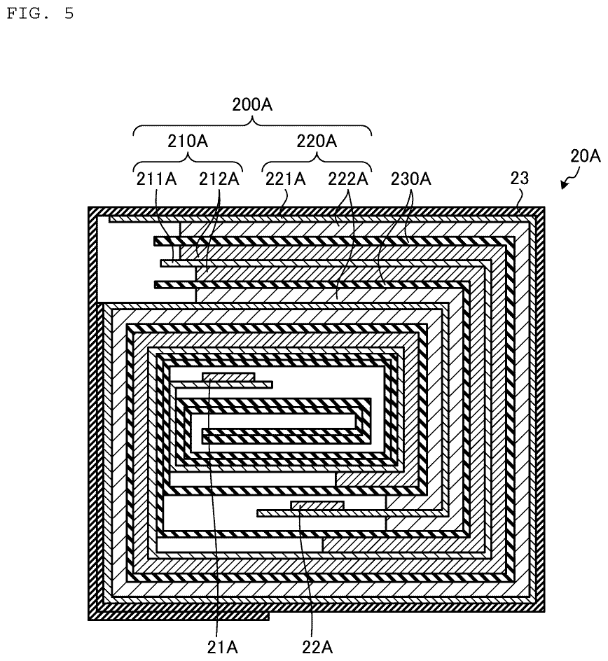

FIG. 4 is a cutaway view illustrating another example of the secondary battery according to the first embodiment. FIG. 5 is a schematic sectional view taken along the line V-V in FIG. 4. A secondary battery 1A illustrated in FIGS. 4 and 5 is different from the example according to FIG. 1 in that the electrode body 200 has a structure in which the electrode body 200 is wound with a positive electrode lead 21A and a negative electrode lead 22A positioned at the center.

A battery element 20A is provided inside the exterior member 30. As illustrated in FIG. 5, the battery element 20A includes an electrode body 200A, a positive electrode lead 21A, a negative electrode lead 22A, and a protective material 23. The positive electrode lead 21A is a terminal drawn out from the inside of the battery element 20A to the outside of the exterior member 30, and the positive electrode lead 21A is provided near the center of the battery element 20A. The negative electrode lead 22A is a terminal drawn out from the inside of the battery element 20A to the outside of the exterior member 30, and the negative electrode lead 22A is provided near the center of the battery element 20A. The protective material 23 is a member that protects the exterior of the battery element 20A. The protective material 23 is provided so as to be wound around the electrode body 200A. The protective material 23 is, for example, an insulator tape.

In the example of FIG. 5, the electrode body 200A is a stack for a charge-discharge reaction of the secondary battery 1A according to the first embodiment. The electrode body 200A includes: a positive electrode 210A including a positive electrode current collector 211A and a positive electrode active material layer 212A; a negative electrode 220A including a negative electrode current collector 221A and a negative electrode active material layer 222A; and a separator 230A. The electrode body 200A has a structure in which the electrode body 200A is wound with the positive electrode lead 21A and the negative electrode lead 22A positioned at the center, and the negative electrode current collector 221A, the negative electrode active material layer 222A, the separator 230A, the positive electrode active material layer 212A, the positive electrode current collector 211A, the positive electrode active material layer 212A, the separator 230A, and the negative electrode active material layer 222A are stacked in this order from the outside, namely, from the protective material 23 side. In the electrode body 200A, layers other than the negative electrode current collector 221A, the separator 230A, or the positive electrode current collector 211A are not provided near the positive electrode lead 21A and the negative electrode lead 22A. With this structure, the positive electrode current collector 211A is connected to the positive electrode lead 21A, and the negative electrode current collector 221A is connected to the negative electrode lead 22A.

As described above, the positive electrode active material according to the first embodiment contains a lithium nickel oxide and the zirconium oxide 212b. The lithium nickel oxide is represented by a composition formula of Li_{d}Ni_{1-a-b-c}CoₐAl_{b}M_{c}O₂, where M is at least one element selected from Na, Cu, W, Fe, and Zn, and 0≤a≤0.2, 0≤b≤0.2, 0≤c≤0.1, and 0.90≤d≤1.1 are satisfied. This can improve the cycle retention rate.

As a desirable aspect, the zirconium oxide 212b covers at least a part of a surface of the lithium nickel oxide. This makes it possible to improve the conductivity between the lithium nickel oxide particles 212a.

As a desirable aspect, the lithium nickel oxide is a particle. The average diameter of the lithium nickel oxide is 0.1 μm or more and 3 μm or less. This can reduce the electrical resistance of the positive electrode active material layer 212A and improve the cycle characteristics.

As a desirable aspect, the crystal system of the zirconium oxide is monoclinic or tetragonal. This can further improve the cycle characteristics.

As a desirable aspect, the mole ratio of the content of the zirconium oxide to the content of nickel in the lithium nickel oxide is 0.0001 or more and 0.01 or less. This can reduce the electrical resistance of the positive electrode active material layer 212A and improve the cycle characteristics.

As a desirable aspect, the carbonate 212c is further included. This can suppress gas generation.

As a desirable aspect, the carbonate 212c covers at least a part of a surface of the lithium nickel oxide. This makes it possible to improve the binding properties between the lithium nickel oxide particles 212a.

As a desirable aspect, the mole ratio of the content of the carbonate 212c to the content of nickel in the lithium nickel oxide is 0.0002 or more and 0.02 or less. This can reduce the electrical resistance of the positive electrode active material layer 212A and improve the cycle characteristics.

As a more desirable aspect, the cation of the carbonate 212c contains at least one element selected from K, Ca, Ba, Mg, Fe, Co, Na, Mn, Ni, Zn, Rb, Sr, Cs, Cd, and Ag. This can further suppress gas generation.

The positive electrode 210 according to the first embodiment contains the positive electrode active material according to the first embodiment. This can improve the cycle retention rate.

The secondary battery 1 according to the first embodiment includes the positive electrode 210 containing the positive electrode active material according to the first embodiment, the negative electrode 220, the separator 230 interposed between the positive electrode 210 and the negative electrode 220, and an electrolytic solution. This can improve the cycle retention rate.

### (Method for Producing Positive Electrode Active Material)

Hereinafter, an example of a method for producing a positive electrode active material according to the first embodiment will be described. The method for producing a positive electrode active material according to the present embodiment is merely an example, and is not limited to the following. The method for producing a positive electrode active material according to the first embodiment includes a lithium nickel oxide production step and a covering step.

In the lithium nickel oxide production step, lithium nickel oxide Li_{d}Ni_{1-a-b-c}CoₐAl_{b}M_{c}O₂ (where M is at least one element selected from Na, Cu, W, Fe, and Zn, and 0≤a≤0.2, 0≤b≤0.2, 0≤c≤0.1, 0.90≤d≤1.1 are satisfied) is produced by the following method. First, produce a sulfate aqueous solution of Ni, Al, and Co. Thereafter, add the sulfate aqueous solution to an alkaline aqueous solution and stir the mixture to precipitate a coprecipitate. Here, the alkaline aqueous solution can be an ammonia aqueous solution and an aqueous solution of a hydroxide of metal M or the like. Thereafter, wash and dry the coprecipitate, and mix lithium hydroxide to produce a precursor. Thereafter, fire the precursor to obtain a lithium nickel oxide.

In the covering step, the lithium nickel oxide is covered with zirconium oxide and a carbonate by the following method. First, charge zirconium alkoxide and a carbonate into a solvent and stir the mixture to produce a solution. Here, the solvent into which the zirconium alkoxide and the carbonate are charged is, for example, isopropyl alcohol (IPA), but the solvent is not particularly limited as long as it is a liquid that dissolves the zirconium alkoxide and the carbonate. Thereafter, add the produced lithium nickel oxide to the solution containing zirconium alkoxide and the carbonate, and further stir the mixture. Thereafter, fire the precursor obtained by removing the solvent through heating and drying, in an atmosphere having a high oxygen concentration to obtain a sintered body. Thereafter, pulverize the sintered body to obtain a positive electrode active material covered with zirconium oxide and the carbonate.

The zirconium alkoxide is a compound represented by the general formula Zr(OR)₄, where R is an alkyl group. Specific examples thereof include zirconium n-propoxide and zirconium n-butoxide.

In the covering step, the amount of zirconium alkoxide added to the solution is preferably 0.0001 or more and 0.01 or less in terms of mole ratio with respect to the content of nickel in the lithium nickel oxide.

In the covering step, the amount of the carbonate to be added to the solution is preferably 0.0002 or more and 0.02 or less in terms of mole ratio with respect to the content of nickel in the lithium nickel oxide.

In the covering step, the firing temperature is preferably 600° C. or more and 800° C. or less. This allows the crystal system of zirconium oxide to be monoclinic or tetragonal, which can improve the cycle retention rate.

Through the above-described steps, the positive electrode active material according to the first embodiment can be produced.

### EXAMPLES

Hereinafter, Examples will be described according to an embodiment. Table 1 is a table showing Examples and Comparative Examples. The present application is not limited by the present Examples. Here, in Table 1, the gas generation amount is a relative value with respect to Example 1, and represents a volume ratio of the gas generated from the battery with respect to Example 1.

TABLE 1

| | Positive electrode | | | | | | | |
|---|---|---|---|---|---|---|---|---|
| | active material | | | | | | | Gas |
| | covering step | | | | | | | generation |
| | Temperature | | | | | | | amount (%) |
| | increase | | | | | | Retention | (Relative |
| | rate | Firing | Oxide | | | | rate after | value with |
| | (° C./ | temperature | Composition | Crystal | Space | | 100 cycles | respect to |
| | min) | (° C.) | formula | system | group | Carbonate | (%) | Example 1) |
| Example 1 | 10 | 680 | ZrO₂ | Monoclinic | P2₁/c | K₂CO₃ | 83 | 100 |
| Example 2 | 10 | 680 | ZrO₂ | Monoclinic | P2₁/c | CaCO₃ | 75 | 103 |
| Example 3 | 10 | 680 | ZrO₂ | Monoclinic | P2₁/c | BaCO₃ | 80 | 103 |
| Example 4 | 10 | 680 | ZrO₂ | Monoclinic | P2₁/c | Na₂CO₃ | 77 | 110 |
| Example 5 | 10 | 680 | ZrO₂ | Monoclinic | P2₁/c | MgCO₃ | 72 | 113 |
| Example 6 | 10 | 680 | ZrO₂ | Monoclinic | P2₁/c | FeCO₃ | 70 | 103 |
| Example 7 | 10 | 680 | ZrO₂ | Monoclinic | P2₁/c | Ag₂CO₃ | 69 | 106 |
| Example 8 | 100 | 750 | ZrO₂ | Tetragonal | P4₂/nmc | K₂CO₃ | 74 | 106 |
| Example 9 | 100 | 750 | ZrO₂ | Tetragonal | P4₂/nmc | CaCO₃ | 72 | 97 |
| Example 10 | 100 | 750 | ZrO₂ | Tetragonal | P4₂/nmc | BaCO₃ | 73 | 103 |
| Example 11 | 50 | 900 | ZrO₂ | Cubic | Fm3⁻m | K₂CO₃ | 48 | 126 |
| Comparative | 10 | 700 | Al₂O₃ | Trigonal | R3⁻c | K₂CO₃ | 45 | 129 |
| Example 1 | | | | | | | | |
| Comparative | — | — | — | — | — | — | 45 | 161 |
| Example 2 | | | | | | | | |
| Example 12 | 10 | 680 | ZrO₂ | Monoclinic | P2₁/c | Li₂CO₃ | 56 | 148 |
| Example 13 | 10 | 680 | ZrO₂ | Monoclinic | P2₁/c | — | 52 | 152 |

### Example 1

The positive electrode active material according to Example 1 was produced by the following method.

As a lithium nickel oxide production step, the lithium nickel oxide according to Example 1 was produced by the following method.

First, nickel (II) sulfate heptahydrate, aluminum sulfate, and cobalt sulfate were dissolved in distilled water to obtain a sulfate aqueous solution of Ni, Al, and Co. The sulfate aqueous solution of Ni, Al, and Co was produced such that the mole ratio of Ni, Al, and Co was 10:1:1 and the sum of the mole concentrations of ions of Ni, Al, and Co was 1.5 mol/L.

Thereafter, an ammonium aqueous solution having a concentration of 1.5 mol/L was charged into a reaction tank having a volume of 2 L, the reaction tank was heated to 50° C. with a heater, and the sulfate aqueous solution was added while stirring with a paddle type stirring blade. The sulfate aqueous solution was added at an addition rate of 5.0 g/min over 24 hours. The sulfate aqueous solution was added so as to maintain a pH of 11.0. A coprecipitate was thus precipitated.

The obtained coprecipitate was washed by repeating pressurized filtration and dispersion in distilled water to remove impurities. The washing was finished when the electrical conductivity of the filtrate was less than 20 mS/m. The washed coprecipitate was dried by heating at 100° C. for 10 hours.

The obtained coprecipitate and lithium hydroxide were mixed such that the mole ratio of Li to the total amount of Ni, Al, and Co was 1.04 to obtain a precursor. Then, the precursor was pre-fired at 500° C. for 5 hours in an oxygen atmosphere, and then mainly fired at 730° C. for 16 hours to obtain lithium nickel oxide particles.

Thereafter, as the covering step, the lithium nickel oxide particles were covered with zirconium oxide and a carbonate by the following method.

Zirconium (IV) n-propoxide in an amount of 0.250 g (0.76 mmol) and 0.250 g (1.81 mmol) of potassium carbonate (K₂CO₃) as the carbonate were charged into 62.50 g of isopropyl alcohol (IPA) as a solvent, and the mixture was stirred for 10 minutes to produce a solution. After stirring, 60 g (nickel content: 0.79 mol) of the lithium nickel oxide particles produced as described above was added to the solution, and the mixture was stirred at room temperature for 30 minutes.

After stirring, the mixture was heated and dried at 100° C. for 3 hours to remove the solvent, whereby powder of the precursor of the positive electrode active material was obtained. The powder of the precursor of the positive electrode active material was compacted into pellets. Then, the precursor of the positive electrode active material was heated at a temperature increase rate of 10° C./min in an atmosphere having an oxygen concentration of 97 vol % or more, fired at 680° C. for 20 hours, and cooled to 30° C. at a temperature decrease rate of 5° C./min to obtain a sintered body. The sintered body was pulverized in a mortar, and then sieved through a sieve with a mesh size of 90 μm to remove coarse particles, whereby powder of the positive electrode active material according to Example 1 was obtained.

Thereafter, 95 mass % of the powder of the produced positive electrode active material, 3 mass % of carbon black as a positive electrode conductive additive, and 2 mass % of polyvinylidene fluoride as a positive electrode binder were mixed and dispersed in N-methyl-2-pyrrolidone (NMP) to produce a positive electrode mixture in slurry form.

Thereafter, the positive electrode mixture in slurry form was uniformly applied to a strip-shaped aluminum foil (positive electrode current collector) having a thickness of 15 μm to form a coating film. Next, the coating film was dried with hot air, and then subjected to compression molding with a roll press machine to form a positive electrode sheet having a positive electrode active material layer. The produced positive electrode sheet was punched to a diameter of 16.5 mm, and vacuum-dried at 120° C. for 10 hours using a vacuum dryer to obtain a positive electrode according to Example 1.

The negative electrode according to Example 1 was produced by stacking a negative electrode active material layer on a negative electrode current collector layer. The negative electrode active material layer according to Example 1 was produced by punching a metal lithium (Li) foil having a thickness of 0.24 mm into a disk having a diameter of 17 mm. The negative electrode current collector layer according to Example 1 was a plate made of stainless steel (SUS) having a thickness of 200 μm.

The separator according to Example 1 was produced by punching a polyolefin sheet having a thickness of 15 μm into a disk shape having a diameter of 17.5 mm.

The electrolytic solution according to Example 1 was produced by dissolving lithium hexafluorophosphate (LiPF₆) as a solute in a solvent obtained by mixing 30 mass % of ethylene carbonate (EC) and 70 mass % of ethyl methyl carbonate (EMC) so as to have a concentration of 1 mol/L.

The battery according to Example 1 was produced by the following method. First, the produced negative electrode was disposed in a cup-shaped anode cup made of stainless steel. At this time, the negative electrode current collector was disposed so as to be in contact with the anode cup. Thereafter, the produced separator was stacked on the negative electrode active material layer. Thereafter, the separator was impregnated with 150 μL of the produced electrolytic solution so that the electrolytic solution also penetrated into voids between the negative electrode and the anode cup. Thereafter, the positive electrode produced as described above was stacked such that the positive electrode active material layer was in contact with the separator. Thereafter, an aluminum plate was stacked on the positive electrode current collector layer of the positive electrode, and a cup-shaped cathode cup made of stainless steel was stacked on the aluminum plate. A gasket made of an insulating material was provided between the peripheral edge of the anode cup and the peripheral edge of the cathode cup, and the anode cup and the cathode cup were sealed with a crimping machine to form an exterior body, whereby the battery according to Example 1 was produced.

### <<Analysis of Positive Electrode Active Material>>

The produced lithium nickel oxide particles were subjected to ICP emission spectrometry to confirm that the composition formula was Li_{1.04}Ni_{0.84}Co_{0.08}Al_{0.08}O₂. A section of the produced positive electrode active material layer was observed with SEM and EDX, and it was confirmed that the positive electrode active material layer contained a plurality of lithium nickel oxide particles, zirconium oxide and the carbonate were distributed at the interface or a part of a surface of the lithium nickel oxide particles, and the zirconium oxide and the carbonate covered at least a part of the surface of the lithium nickel oxide.

The section of the produced positive electrode was measured with SEM, and the average diameter of the lithium nickel oxide particles was measured. In the measurement of the average diameter, the longest distance of the region surrounded by the surfaces or interfaces of 20 lithium nickel oxide particles in the SEM observation image was calculated for each particle, and the arithmetic average value of the longest distances was calculated to calculate the average diameter of the lithium nickel oxide particles. The average diameter of the lithium nickel oxide particles according to Example 1 was 0.5 μm.

### <<Initial Charge-Discharge Test>>

The produced battery was subjected to an initial charge-discharge test. The initial charge-discharge test was performed in a thermostatic bath at 25° C. In the initial charge-discharge test, the produced battery was subjected to constant-current constant-voltage charge up to an upper limit voltage of 4.25 V/a lower limit current of 0.005 C at a current of 0.1 C, then paused for 10 minutes, and discharged up to a lower limit voltage of 2.0 V at a current of 0.1 C to confirm that charge-discharge was possible.

### <<Charge-Discharge Cycle Test>>

The produced battery was subjected to a charge-discharge cycle test. In the charge-discharge cycle test, a charge-discharge cycle was performed in a thermostatic bath at 60° C. In the charge-discharge cycle, the produced battery was paused for 3 hours in advance, then charged at a constant current and constant voltage up to an upper limit voltage of 4.25 V and a lower limit current of 0.01 C at a current of 1.0 C, paused for 1 minute, then discharged up to a lower limit voltage of 2.5 V at a current of 5.0 C, and paused for 5 minutes. In the charge-discharge cycle test, the discharge capacity of the battery after 100 cycles of the charge-discharge cycle was measured, and the 100 cycle retention rate was calculated as the ratio of the discharge capacity according to the following formula (1).

Cycle retention rate (%)=(discharge capacity after 100 cycles/discharge capacity after 1 cycle)×100 (1)

### <<Gas Generation Amount Evaluation Test>>

The produced battery was subjected to a gas generation amount evaluation test. In the gas generation amount evaluation test, float charging was performed in a thermostatic bath at 60° C. In the gas generation amount evaluation test, the produced battery was paused for 3 hours in advance, float-charged at an upper limit voltage of 4.25 V at a current of 1.0 C, the current was continuously caused to flow for 100 hours so as to maintain 4.25 V, and then the battery was discharged to a lower limit voltage of 2.0 V at 1.0 C at 25° C. After the discharge, the volume of the gas generated from the battery was measured by the Archimedes method, and the gas generation amount was calculated.

### Example 2

In Example 2, a battery was produced in the same manner as in Example 1 except that calcium carbonate (CaCO₃) was used as the carbonate as shown in Table 1, and the measurement was performed.

### Example 3

In Example 3, a battery was produced in the same manner as in Example 1 except that barium carbonate (BaCO₃) was used as the carbonate as shown in Table 1, and the measurement was performed.

### Example 4

In Example 4, a battery was produced in the same manner as in Example 1 except that sodium carbonate (Na₂CO₃) was used as the carbonate as shown in Table 1, and the measurement was performed.

### Example 5

In Example 5, a battery was produced in the same manner as in Example 1 except that magnesium carbonate (MgCO₃) was used as the carbonate as shown in Table 1, and the measurement was performed.

### Example 6

In Example 6, a battery was produced in the same manner as in Example 1 except that iron carbonate (FeCO₃) was used as the carbonate as shown in Table 1, and the measurement was performed.

### Example 7

In Example 7, a battery was produced in the same manner as in Example 1 except that silver carbonate (Ag₂CO₃) was used as the carbonate as shown in Table 1, and the measurement was performed.

### Example 8

In Example 8, a battery was produced in the same manner as in Example 1 except that the firing rate in the covering step was 100° C./min, and the firing temperature was 750° C. as shown in Table 1, and the measurement was performed.

### Example 9

In Example 9, a battery was produced in the same manner as in Example 1 except that calcium carbonate (CaCO₃) was used as the carbonate, the firing rate in the covering step was 100° C./min, and the firing temperature was 750° C. as shown in Table 1, and the measurement was performed.

### Example 10

In Example 10, a battery was produced in the same manner as in Example 1 except that barium carbonate (BaCO₃) was used as the carbonate, the firing rate in the covering step was 100° C./min, and the firing temperature was 750° C. as shown in Table 1, and the measurement was performed.

### Example 11

In Example 11, a battery was produced in the same manner as in Example 1 except that the firing rate in the covering step was 50° C./min, and the firing temperature was 900° C. as shown in Table 1, and the measurement was performed.

### Comparative Example 1

In Comparative Example 1, as shown in Table 1, a battery was produced in the same manner as in Example 1 except that lithium nickel oxide was covered with aluminum oxide instead of zirconium oxide by using aluminum alkoxide instead of zirconium alkoxide in the covering step, and the firing temperature was 700° C., and the measurement was performed.

### Comparative Example 2

In Comparative Example 2, a battery was produced in the same manner as in Example 1 except that the step of covering lithium nickel oxide was not performed as shown in Table 1, and the measurement was performed.

### Example 12

In Example 12, a battery was produced in the same manner as in Example 1 except that lithium carbonate (Li₂CO₃) was used as the carbonate as shown in Table 1, and the measurement was performed.

### Example 13

In Example 13, a battery was produced in the same manner as in Example 1 except that no carbonate was used in the covering step as shown in Table 1, and the measurement was performed.

As shown in Table 1, in Examples 1 to 13, when the positive electrode active material contained zirconium oxide, it was possible to improve the cycle retention rate as compared with Comparative Example 1 and Comparative Example 2 in which the positive electrode active material did not contain zirconium oxide.

As shown in Table 1, in Examples 1 to 10, 12, and 13, the crystal system of zirconium oxide was monoclinic or tetragonal, which was able to further improve the cycle characteristics as compared with Example 11 in which the crystal system of zirconium oxide was cubic.

As shown in Table 1, in Examples 1 to 12, because the positive electrode active material contained a carbonate, it was possible to further suppress the gas generation amount as compared with Example 13 and Comparative Example 2 in which the positive electrode active material contained no carbonate.

As shown in Table 1, in Examples 1 to 11, by using a carbonate other than lithium carbonate, it was possible to further suppress the gas generation amount as compared with Example 12 in which the carbonate was lithium carbonate.

An embodiment of the present application described herein is intended to facilitate understanding of the present application, but is not intended to limit the present application. The present application can be modified or improved without departing from the present application, and the present application includes equivalents thereof.

The present application is described in further detail below according to an embodiment.

(1)

A positive electrode active material including:
a lithium nickel oxide; and
zirconium oxide,
wherein the lithium nickel oxide is represented by a composition formula of Li_{d}Ni_{1-a-b-c}CoₐAl_{b}M_{c}O₂, where M is at least one element selected from Na, Cu, W, Fe, and Zn, and 0≤a≤0.2, 0≤b≤0.2, 0≤c≤0.1, and 0.90≤d≤1.1 are satisfied.
   (2)

The positive electrode active material according to (1), wherein the zirconium oxide covers at least a part of a surface of the lithium nickel oxide.

(3)

The positive electrode active material according to (1) or (2), wherein
the lithium nickel oxide is a particle, and
the lithium nickel oxide has an average particle diameter of 0.1 μm or more and 3 μm or less.
   (4)

The positive electrode active material according to any one of (1) to (3), wherein the zirconium oxide has a crystal system of a monoclinic crystal system or a tetragonal crystal system.

(5)

The positive electrode active material according to any one of (1) to (4), wherein a mole ratio of a content of the zirconium oxide to a content of nickel in the lithium nickel oxide is 0.0001 or more and 0.01 or less.

(6)

The positive electrode active material according to any one of (1) to (5), further including a carbonate.

(7)

The positive electrode active material according to (6), wherein the carbonate covers at least a part of a surface of the lithium nickel oxide.

(8)

The positive electrode active material according to (6) or (7), wherein a mole ratio of a content of the carbonate to a content of nickel in the lithium nickel oxide is 0.0002 or more and 0.02 or less.

(9)

The positive electrode active material according to any one of (6) to (8), wherein a cation of the carbonate contains at least one element selected from K, Ca, Ba, Mg, Fe, Co, Na, Mn, Ni, Zn, Rb, Sr, Cs, Cd, and Ag.

(10)

A positive electrode including the positive electrode active material according to any one of (1) to (9).

(11)

A secondary battery including a positive electrode containing the positive electrode active material according to any one of (1) to (9), a negative electrode, a separator interposed between the positive electrode and the negative electrode, and an electrolytic solution.

### DESCRIPTION OF REFERENCE SYMBOLS

1, 1A: Secondary battery
20, 20A: Battery element
21, 21A: Positive electrode lead
22, 22A: Negative electrode lead
23: Protective material
30: Exterior member
30a, 30b: Exterior sheet
31: Recess
32: Close contact member
200, 200A: Electrode body
210, 210A: Positive electrode
211, 211A: Positive electrode current collector
212, 212A: Positive electrode active material layer
220, 220A: Negative electrode
221, 221A: Negative electrode current collector
222, 222A: Negative electrode active material layer
230, 230A: Separator

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A positive electrode active material comprising:
a lithium nickel oxide; and
zirconium oxide,
wherein the lithium nickel oxide is represented by a composition formula of Li_{d}Ni_{1-a-b-c}CoₐAl_{b}M_{c}O₂, where M is at least one element selected from Na, Cu, W, Fe, and Zn, and 0≤a≤0.2, 0≤b≤0.2, 0≤c≤0.1, and 0.90≤d≤1.1 are satisfied, and wherein
the lithium nickel oxide is a particle, and
the lithium nickel oxide has an average particle diameter of 0.1 μm or more and 3 μm or less.

2. The positive electrode active material according to claim 1, wherein the zirconium oxide has a crystal system of a monoclinic crystal system or a tetragonal crystal system.

3. The positive electrode active material according to claim 1, wherein a mole ratio of a content of the zirconium oxide to a content of nickel in the lithium nickel oxide is 0.0001 or more and 0.01 or less.

4. The positive electrode active material according to claim 1, further comprising a carbonate.

5. The positive electrode active material according to claim 4, wherein the carbonate covers at least a part of a surface of the lithium nickel oxide.

6. The positive electrode active material according to claim 4, wherein a mole ratio of a content of the carbonate to a content of nickel in the lithium nickel oxide is 0.0002 or more and 0.02 or less.

7. The positive electrode active material according to claim 4, wherein a cation of the carbonate contains at least one element selected from K, Ca, Ba, Mg, Fe, Co, Na, Mn, Ni, Zn, Rb, Sr, Cs, Cd, and Ag.

8. A positive electrode comprising the positive electrode active material according to a claim 1.

9. A secondary battery comprising:
a positive electrode containing the positive electrode active material according to claim 1;
a negative electrode;
a separator interposed between the positive electrode and the negative electrode; and
an electrolytic solution.

10. A positive electrode active material comprising:
a lithium nickel oxide; and
zirconium oxide,
wherein the lithium nickel oxide is represented by a composition formula of Li_{d}Ni_{1-a-b-c}CoₐAl_{b}M_{c}O₂, where M is at least one element selected from Na, Cu, W, Fe, and Zn, and 0≤a≤0.2, 0≤b≤0.2, 0≤c≤0.1, and 0.90≤d≤1.1 are satisfied,
wherein the zirconium oxide covers at least a part of a surface of the lithium nickel oxide, and
wherein
the lithium nickel oxide is a particle, and
the lithium nickel oxide has an average particle diameter of 0.1 μm or more and 3 μm or less.

11. The positive electrode active material according to claim 10, wherein the zirconium oxide has a crystal system of a monoclinic crystal system or a tetragonal crystal system.

12. The positive electrode active material according to claim 10, wherein a mole ratio of a content of the zirconium oxide to a content of nickel in the lithium nickel oxide is 0.0001 or more and 0.01 or less.

13. The positive electrode active material according to claim 10, further comprising a carbonate.

14. The positive electrode active material according to claim 13, wherein the carbonate covers at least a part of a surface of the lithium nickel oxide.

15. The positive electrode active material according to claim 13, wherein a mole ratio of a content of the carbonate to a content of nickel in the lithium nickel oxide is 0.0002 or more and 0.02 or less.

16. The positive electrode active material according to claim 13, wherein a cation of the carbonate contains at least one element selected from K, Ca, Ba, Mg, Fe, Co, Na, Mn, Ni, Zn, Rb, Sr, Cs, Cd, and Ag.

17. A positive electrode comprising the positive electrode active material according to claim 10.

18. A secondary battery comprising:
a positive electrode containing the positive electrode active material according to claim 10;
a negative electrode;
a separator interposed between the positive electrode and the negative electrode; and
an electrolytic solution.
